(19) United States
(12) Patent Application Publication
(10) Pub. No.: US 2026/0180113 A1
(43) Pub. Date: Jun. 25, 2026

(54) PRISMATIC BATTERY MODULE ARCHITECTURE USING ALTERNATING BATTERY CELL CHEMISTRIES

(71) Applicant: GM GLOBAL TECHNOLOGY OPERATIONS LLC, Detroit, MI (US)

(72) Inventors: Ryan Patrick Hickey, Austin, TX (US); Andrew A. Raftopoulos, Auburn Hills, MI (US); Rui Zhang, Rochester Hills, MI (US)

(73) Assignee: GM GLOBAL TECHNOLOGY OPERATIONS LLC, Detroit, MI (US)

(21) Appl. No.: 18/986,907

(22) Filed: Dec. 19, 2024

(51) Int. Cl. H01M 50/293; H01M 10/42; H01M 10/658; H01M 50/209; H01M 50/249; H01M 50/507

(52) U.S. Cl. CPC H01M 50/293; H01M 10/425; H01M 10/658; H01M 50/209; H01M 50/249; H01M 50/507; H01M 2220/20

(57) ABSTRACT

The present disclosure teaches prismatic battery modules having prismatic repeating battery sub-units with alternating pairs of a high Energy Density (HED) battery cell stacked next to a low Energy Density (LED) battery cell. A ratio of the high energy density divided by the low energy density may be greater than 1.3. Additionally, a thermal barrier may be placed in-between adjacent HED and LED battery cells. Optionally, a LED battery cell may serve as a thermal damper when placed in-between adjacent HED and LED battery cells, thereby reducing the total number of thermal barriers needed. High voltage HED and LED electrical buses may be placed in offset positions according to each HED or LED cell type, so that both types of high voltage electrical buses may be located on a same side of each battery module.

### INTRODUCTION

This disclosure relates to various prismatic battery module architectures used for battery-electric or hybrid-electric automotive vehicles, or other battery-powered applications, which have alternating pairs of High Energy Density (HED) battery cells and Low Energy Density (LED) battery cells, with (or without) thermal barriers positioned in-between adjacent HED and LED battery cells.

The Rechargeable Energy Storage System (RESS) used in electric vehicles (EVs) achieves a desired operating performance by electrically interconnecting several battery cells using a combination of series and parallel electrical connections. Each cell interconnected in a single serial string of N-battery cells adds up each cell's individual voltage potential to reach a desired total terminal voltage for the single series string. Parallel interconnections, on the other hand, generate a higher total capacity (i.e., current (Amps) and energy capacity (Amp-hour) by adding up the currents and ampere-hour (Ah) energy capacities of M-parallel strings of N-cells connected in series.

Battery pack designs may be configured to optimize the overall thermal performance of a battery-powered electrical system. Such thermal optimization may also increase the total energy density of the battery pack, while reducing the overall pack space that is dedicated to thermal barriers that may be placed in-between adjacent battery cells.

### SUMMARY

The present disclosure teaches prismatic battery modules that have prismatic repeating battery sub-units with alternating pairs of a High Energy Density (HED) battery cell (having a high energy density and a low thermal stability) that is stacked next to a Low Energy Density (LED) battery cell (having a low energy density and a high thermal stability). A ratio of the high energy density divided by the low energy density may be greater than 1.3. Additionally, a thermal barrier may be placed in-between adjacent HED and LED battery cells. Optionally, a LED battery cell may also serve as a thermal damper when placed in-between adjacent HED and LED battery cells, thereby reducing the total number of thermal barriers needed. High Voltage (HV) HED and LED electrical buses may be placed in offset positions according to each HED or LED cell type, so that both types of HV electrical buses may be located on a same side of each battery module.

In an embodiment, a battery module may include: (a) a first prismatic repeating battery sub-unit including a first HED battery cell, and a first LED battery cell. The first HED battery cell has a high energy density, and the first LED battery cell has a low energy density. The battery module further includes (b) a second prismatic repeating battery sub-unit, which includes: a second HED battery cell and a second LED battery cell. The second HED battery cell has the high energy density and the second LED battery cell has the low energy density, where the high energy density is greater than the low energy density, and where the second prismatic repeating battery sub-unit is stacked adjacent to the first prismatic repeating sub-unit.

In an embodiment, the battery module may further include a first thermal barrier and a second thermal barrier, where the first thermal barrier may be positioned in-between the first HED battery cell and the first LED battery cell, and further where the second thermal barrier is positioned in-between the first LED battery cell and the second HED battery cell.

In an embodiment, the battery module may include a thermal barrier, where the first HED battery cell is positioned directly adjacent to the first LED battery cell, and the thermal barrier may be positioned in-between the first LED cell and the second HED cell. In this embodiment, a thermal barrier is not disposed in-between the first HED battery cell and the first LED battery cell.

In an embodiment, both the first HED battery cell and the second HED battery cell may have a lithium-nickel-manganese-cobalt battery chemistry, a lithium-nickel-cobalt-aluminum oxide battery chemistry, a lithium-manganese oxide chemistry, a lithium manganese-rich chemistry, or a sodium-ion based battery chemistry, and/or combinations thereof.

In an embodiment, both the first LED battery cell and the second LED battery cell may have a lithium-iron-phosphate battery chemistry or a lithium manganese-rich chemistry, and/or combinations thereof.

In an embodiment, both the first HED battery cell and the second HED battery cell may have a lithium-nickel-manganese-cobalt battery chemistry or a lithium-nickel-cobalt-aluminum oxide battery chemistry or a sodium-ion based battery chemistry, and/or combinations thereof; and both the first LED battery cell and the second LED battery cell may have a lithium-iron-phosphate battery chemistry.

In an embodiment, a ratio of the high energy density divided by the low energy density may be greater than about 1.1.

In an embodiment, the ratio of the high energy density divided by the low energy density may be greater than about 1.3.

In an embodiment, a thermal barrier may be made of an aerogel material, a compressed foam material, mica, ceramic fibers, ceramic wool, or a metallic material, and/or combinations thereof.

In an embodiment, a thermal barrier may have a thickness ranging from about 1 mm to about 10 mm.

In an embodiment, a battery module may include a first prismatic repeating battery sub-unit that has four adjacent positions: #1, #2, #3, and #4, defined within the first prismatic repeating battery sub-unit, that are stacked in increasing sequential order from a position #1 to a position #2 to a position #3 to a position #4, and a first High Energy Density (HED) battery cell located at the position #1, a first Type-A thermal barrier (TB-A) located at the position #2, a first LED battery cell located at the position #3, and a first Type-B thermal barrier (TB-B) located at the position #4. The first HED battery cell has a high energy density, where the first LED battery cell has a low energy density and where the high energy density is greater than the low energy density.

In an embodiment, the first TB-A may be made of a different composition and/or may have a different thickness than the first TB-B.

In an embodiment, both the first TB-A and the first TB-B may have a same composition and/or may have a same thickness.

In an embodiment, the battery module may include a second prismatic repeating battery sub-unit stacked adjacent to the first prismatic repeating battery sub-unit, where the second prismatic repeating battery sub-unit comprises a same stacking order as the first prismatic repeating battery sub-unit, where the second prismatic repeating battery sub-unit includes: a second HED battery cell located at the position #1, a second TB-A, located at the position #2, a second LED battery cell, located at the position #3, and a second TB-B, located at the position #4. The second HED battery cell has the high energy density and the second LED battery cell has the low energy density.

In an embodiment, the battery module may further include a third prismatic repeating battery sub-unit stacked adjacent to the second prismatic repeating battery sub-unit, where the third prismatic repeating battery sub-unit has the same stacking order as the first prismatic repeating battery sub-unit. The third prismatic repeating battery sub-unit in this embodiment includes: a third HED battery cell located at the position #1, a third TB-A located at the position #2, a third LED battery cell located at the position #3, and a third TB-B located at the position #4. The third HED battery cell has the high energy density and the third LED battery cell has the low energy density.

In an embodiment, the battery module may further include a fourth prismatic repeating battery sub-unit stacked adjacent to the third prismatic repeating battery sub-unit. The fourth prismatic repeating battery sub-unit in this embodiment has the same stacking order as the first prismatic repeating battery sub-unit. The fourth prismatic repeating battery sub-unit may also have: a fourth HED battery cell located at the position #1, a fourth TB-A located at the position #2, a fourth LED battery cell located at the position #3, and a fourth TB-B located at the position #4. The fourth HED battery cell has the high energy density and the fourth LED battery cell has the low energy density.

In an embodiment, the battery module may further include a fifth prismatic repeating battery sub-unit stacked adjacent to the fourth prismatic repeating battery sub-unit. The fifth prismatic repeating battery sub-unit has the same stacking order as the first prismatic repeating battery sub-unit. The fifth prismatic repeating battery sub-unit may have: a fifth HED battery cell located at the position #1, a fifth TB-A located at the position #2, a fifth LED battery cell located at the position #3, and a fifth TB-B, located at the position #4. The fifth HED battery cell in this embodiment has the high energy density and the fifth LED battery cell has the low energy density.

In an embodiment, the battery module may further include a sixth prismatic repeating battery sub-unit stacked adjacent to the fifth prismatic repeating battery sub-unit. The sixth prismatic repeating battery sub-unit has the same stacking order as the first prismatic repeating battery sub-unit. The sixth prismatic repeating battery sub-unit may have: a sixth HED battery cell located at the position #1, a sixth TB-A located at the position #2, a sixth LED battery cell located at the position #3, and a sixth TB-B located at the position #4. The sixth HED battery cell in this embodiment has the high energy density and the sixth LED battery cell has the low energy density.

In an embodiment, a battery module may include a first negative HED terminal disposed on the first HED battery cell, a second negative HED terminal disposed on the second HED battery cell, a third negative HED terminal disposed on the third HED battery cell, a fourth negative HED terminal disposed on the fourth HED battery cell, a fifth negative HED terminal disposed on the fifth HED battery cell, and a sixth negative HED terminal disposed on the sixth HED battery cell. The battery module in this embodiment also includes: a first positive HED terminal disposed on the first HED battery cell, a second positive HED terminal disposed on the second HED battery cell, a third positive HED terminal disposed on the third HED battery cell, a fourth positive HED terminal disposed on the fourth HED battery cell, a fifth positive HED terminal disposed on the fifth HED battery cell, and a sixth positive HED terminal disposed on the sixth HED battery cell.

Additionally, in this embodiment the battery module includes a first negative LED terminal disposed on the first LED battery cell, a second negative LED terminal disposed on the second LED battery cell, a third negative LED terminal disposed on the third LED battery cell, a fourth negative LED terminal disposed on the fourth LED battery cell, a fifth negative LED terminal disposed on the fifth LED battery cell, and a sixth negative LED terminal disposed on the sixth LED battery cell.

This representative embodiment of the battery module may also include a first positive LED terminal disposed on the first LED battery cell, a second positive LED terminal disposed on the second LED battery cell, a third positive LED terminal disposed on the third LED battery cell, a fourth positive LED terminal disposed on the fourth LED battery cell, a fifth positive LED terminal disposed on the fifth LED battery cell, and a sixth positive LED terminal disposed on the sixth LED battery cell.

In an embodiment, a battery module may include a first HED bus electrically connecting the first positive HED terminal to the second positive HED terminal and to the third negative HED terminal and to the fourth negative HED terminal, a second HED bus electrically connecting the third positive HED terminal to the fourth positive HED terminal and to the fifth negative HED terminal and to the sixth positive HED terminal, a first LED bus electrically connecting the first positive LED terminal to the second positive LED terminal and to the third negative LED terminal and to the fourth negative LED terminal, and a second LED bus electrically connecting the third positive LED terminal to the fourth positive LED terminal and to the fifth negative LED terminal and to the sixth negative LED terminal.

In an embodiment, a battery module may include a first side and an opposing second side. The first HED bus and the second HED bus may be located on the first side, and the first LED bus and the second LED bus may be located on the opposing second side.

In an embodiment, the first HED bus and the second HED bus are located on the same side of the battery module as the first LED bus and the second LED bus.

In an embodiment, a vehicle body may include a set of road wheels connected to the vehicle body, an electric traction motor rotatably connected to at least one road wheel of the set of road wheels; and a battery module electrically connected to the electric traction motor and configured to energize the electric traction motor to cause rotation of the at least one road wheel, with the battery module including: a prismatic repeating battery sub-unit including: a High Energy Density (HED) battery cell having a high energy density, and a Low Energy Density (LED) battery cell having a low energy density, where the high energy density is greater than the low energy density.

In an embodiment, a battery pack may include (a) a first battery module, (b) a second battery module, and (c) a Battery Disconnect Unit (BDU) having a positive BDU tab and a negative BDU tab. The first battery module is electrically connected in parallel to the second battery module and the first battery module has four adjacent positions, i.e., #1, #2, #3, and #4, defined within the first battery module and stacked in increasing sequential order from a position #1 to a position #2 to a position #3 to a position #4. The first battery module may have a first module High Energy Density (HED) battery cell located at the position #1, a first module Type A thermal barrier cell located at the position #2, a first module Low Energy Density (LED) battery cell located at the position #3, a first module Type B thermal barrier cell located at position #4. A first module positive electrical tab is electrically connected to the first module HED battery cell. A first module negative electrical tab is electrically connected to the first module HED battery cell. A first module HED bus is electrically connected to the first module HED battery cell. A first module LED bus is electrically connected to the first module LED battery cell.

Additionally, in this embodiment, the second battery module also has four adjacent positions, i.e., #1, #2, #3, and #4, which are defined within the second battery module and stacked in increasing sequential order from a position #1 to a position #2 to a position #3 to a position #4. The second battery module may have a second module HED battery cell located at the position #1, a second module Type A thermal barrier cell located at the position #2, a second module LED battery cell located at the position #3, and a second module Type B thermal barrier cell located at the position #4. Additionally, a second module positive electrical tab is electrically connected to the second module HED battery cell, a second module negative electrical tab is electrically connected to the second module HED battery cell, a second module HED bus is electrically connected to the second module HED battery cell, and a second module LED bus is electrically connected to the second module LED battery cell.

In an embodiment, the battery module may further include a first conductor electrically connecting the first module positive electrical tab to the first module negative electrical tab, a second conductor electrically connecting the second module positive electrical tab to the second module negative electrical tab, and a third conductor electrically connecting the first module LED bus to the second module negative electrical HED bus. The battery module in this embodiment may also include a fourth conductor electrically connecting the first module HED bus to the negative BDU tab, and a fifth conductor electrically connecting the second module LED bus to the positive BDU tab. The first module HED battery cell has a high energy density and the second module HED battery cell has the high energy density. The first module LED battery cell has a low energy density. The second module LED battery cell has the low energy density. In this embodiment, the high energy density is greater than the low energy density.

In an embodiment, the battery pack may further include a first direct current - direct current (DC-DC) converter electrically connected between the first battery module and the BDU, and a second DC-DC converter electrically connected between the second battery module and the BDU.

### BRIEF DESCRIPTION OF THE DRAWINGS

FIG. 1A shows a front end elevation view of an example of a prismatic battery module.

FIG. 1B shows a top plan view of an example of a prismatic battery module comprising multiple, prismatic repeating sub-units with multiple, alternating pairs of stacked high energy density and low energy density prismatic battery cells separated by thermal barriers.

FIG. 1C shows a High Energy Density (HED) side elevation view of an example of a prismatic battery module comprising multiple, prismatic repeating sub-units with multiple, alternating pairs of stacked high energy density and low energy density prismatic battery cells separated by thermal barriers.

FIG. 1D shows an opposing, Low Energy Density (LED) side elevation view of an example of a prismatic battery module with multiple, prismatic repeating sub-units comprising multiple, alternating pairs of stacked high energy density and low energy density prismatic battery cells separated by thermal barriers.

FIG. 2 shows a perspective view of an example of a prismatic battery module comprising multiple, prismatic repeating sub-units with multiple, alternating pairs of stacked high energy density and low energy density prismatic battery cells separated by thermal barriers.

FIG. 3 shows a side elevation view of an example of a prismatic battery module comprising multiple, prismatic repeating sub-units with multiple, alternating pairs of stacked high energy density and low energy density prismatic battery cells separated by thermal barriers.

FIG. 4 shows a top plan view of an example of a prismatic battery module comprising multiple, prismatic repeating sub-units with multiple, alternating pairs of stacked high energy density and low energy density prismatic battery cells separated by a thermal barrier disposed in-between the low energy density prismatic battery cell and the high energy density prismatic battery cell.

FIG. 5A shows a top plan view of an example of a pair of left and right prismatic battery modules each comprising multiple prismatic repeating sub-units comprising multiple, pairs of stacked alternating high energy density and low energy density prismatic battery cells separated by a thermal barrier, electrically connected to a Battery Disconnect Unit (BDU).

FIG. 5B shows a top plan view of an example of a battery pack comprising a pair of first and second prismatic battery modules that are electrically connected in parallel to a pair of first and second DC-DC converters, and then electrically connected in parallel to a common Battery Disconnect Unit (BDU).

FIG. 6 shows a perspective view of an example of an automobile vehicle and battery tray holding a prismatic battery module comprising multiple, stacked prismatic battery cells.

### DETAILED DESCRIPTION OF THE DISCLOSURE

The prismatic battery modules disclosed herein may be used in number of different mobile electric or hybrid-electric applications, including, but not limited to: automobiles, trucks, motorcycles, boats, submarines, aircraft, drones, spacecrafts, satellites, trains, or other mobile platforms, as well as non-mobile electric systems, such as power plants, appliances, and photovoltaic solar battery storage installations. The phrase “vehicle” is broadly defined as a moving machine, including, but not limited to: automobiles, trucks, motorcycles, boats, submarines, aircraft, drones, spacecrafts, satellites, trains, or other mobile platforms. The term “prismatic” broadly means a six-sided object with 90-degree (square) corners that may have an elongated rectangular, or square (cubical) shape. The term “battery cell” broadly includes both lithium-ion based battery chemistries and sodium-ion battery chemistries. The terms “bus” and “bussing” and “busbar” have the same meaning and are interchangeable. The modifier “about” means that a variable has a range (tolerance) of +/−10% of the stated value of the variable. The terms “battery cell” and “cell” have the same meaning and are interchangeable. The terms “electrical connection” and “connection” have the same meaning and are interchangeable.

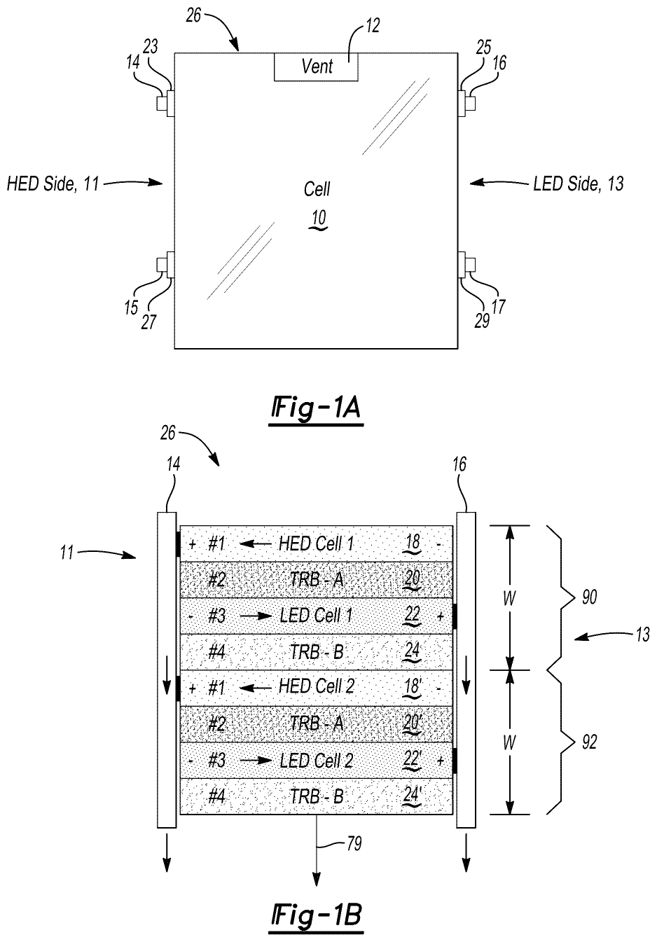

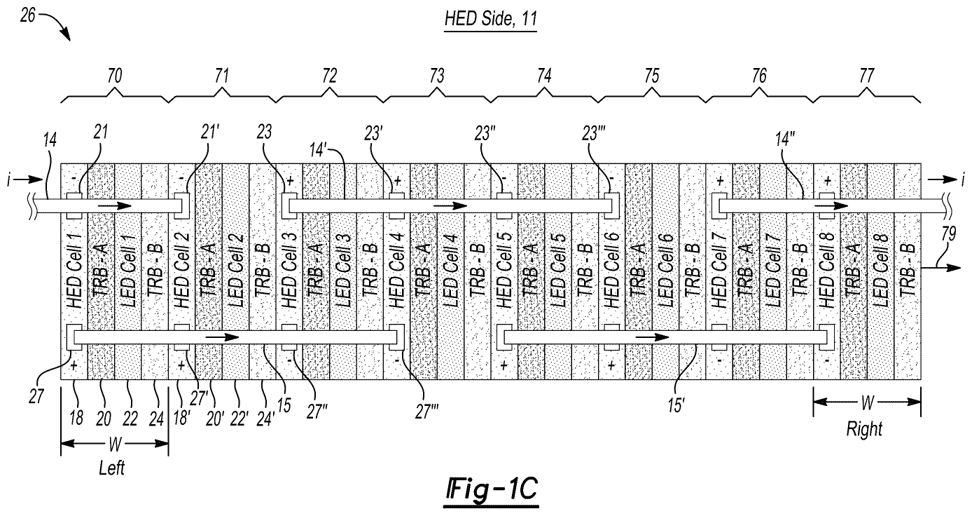

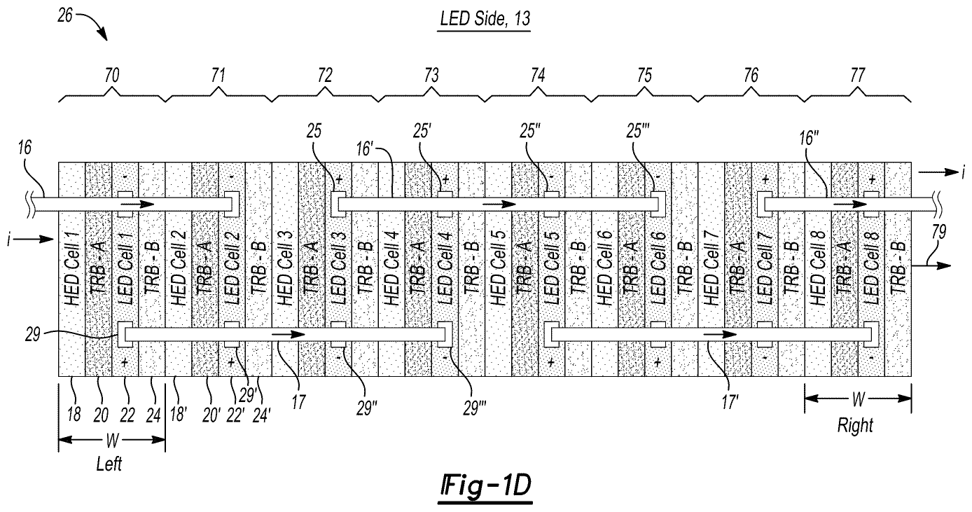

FIG. 1A shows a front end elevation view of an example of a prismatic battery module 26. Prismatic battery module 26 includes at least one prismatic battery cell 10 with a vent 12 for releasing gases from the interior of battery cell 10 that may be generated during a thermal event. Battery module 26 further comprises a High Energy Density (HED) side 11 and an opposite (opposing) Low Energy Density (LED) side 13. On the HED side 11, first HED bus 14 is electrically connected to upper HED battery terminal 23, while second HED bus 15 is electrically connected to lower HED battery terminal 27. On the LED side 13, first LED bus 16 is electrically connected to upper LED battery terminal 25, while second LED bus 17 is electrically connected to lower LED battery terminal 29.

FIG. 1B shows a top plan view of the previous example of the prismatic battery module 26 comprising multiple, prismatic repeating sub-units 90, 92, etc. with multiple pairs of stacked, prismatic HED battery cells 18, 18′, etc. and alternating prismatic LED battery cells 22, 22′, etc., respectively, which are separated by two types of thermal barriers (TB): TB-A 20, 20′, etc. and TB-B 24, 24′, etc., respectively, TB-A 20 is disposed in-between first HED battery cell 18 and first LED battery cell 22, while TB-B 24 is disposed in-between first LED battery cell 22 and second HED battery cell 18′. Each repeating battery sub-unit 90, 92, etc. has four positions: #1, #2, #3, and #4, in increasing sequential order. First HED cell 18 is located at position #1; first TB-A 20 is located at position #2; first LED cell 22 is located at position #3; and first TB-B 24 is located at position #4. A width, W, of each repeating battery sub-unit 90, 92, etc. is identified in FIG. 1B. The downwards-pointing arrow 79 illustrated at the bottom of FIG. 1B indicates that battery module 26 may have as many multiple, repeating sub-units 90, 92, etc. as is needed to supply the desired current and voltage levels needed for a specific battery architecture.

Referring still to FIG. 1B, battery module 26 may further comprise a positive HED electrical bus 14 located on HED side 11, which electrically connects sequential HED battery cells 18, 18′, etc. in series, according to the specified battery architecture design. Battery module 26 may further comprise a positive LED electrical bus 16 located on the opposite (opposing) LED side 13, which electrically connects sequential LED battery cells 22, 22′, etc. in series, according to the specific battery architecture design.

FIG. 1C shows a HED side 11 elevation view of the previous example of the prismatic battery module 26 comprising at least eight, prismatic repeating sub-units 70, 71, 72, 73, 74, 75, 76, and 77 with at least eight, alternating pairs of stacked HED prismatic battery cells 18, 18′, etc. and stacked LED prismatic battery cells 22, 22′, etc., respectively, that are separated by eight, alternating pairs of Type-A and Type-B thermal barriers 20, 20′, etc. and 24, 24′, etc., respectively, that are disposed in-between the HED and LED cells. The specific battery architecture used in this embodiment of battery module 26 is an “2P8S2AC” architecture, wherein each repeating battery sub-unit 70, 71, 72, etc. comprises two Parallel groups and eight Series groups of cells arranged in two Alternating Chemistries (i.e., “2P4S2AC”). Direct (DC) battery current, i, flows from left to right in module 26, when connected to a load (such as a traction motor (not shown)). The sideways-pointing arrow 79 (pointing to the right-hand side of FIG. 1B) indicates that battery module 26 may have as many multiple, repeating sub-units 70, 71, 72, etc. as is needed to supply the desired current and voltage levels needed for a specific battery architecture. The high outlet voltage, Vₒᵤₜ, developed by HED cells 18, 18′, etc. connected in series is given by Vₒᵤₜ=N×V_{cell}, where N=8 cells connected in series and V_{cell}=5 volts. In this specific example, Vₒᵤₜ=8×5=40 volts. With an inlet voltage, Vᵢₙ, of module 26 being equal to zero, then the voltage drop across the module from inlet to outlet is equal to 40−0=40 volts, in this example. Each HED bus 14, 15, 14′, 15′, and 14″ has a directional arrow indicating the flow of current, i, from left to right through each HED bus, in a serpentine fashion, during a battery discharge cycle. The current flow direction would reverse in a charging cycle.

Referring still to FIG. 1C, HED bus 14 electrically connects HED cell 1 to HED cell 2. HED bus 14′ electrically connects positive terminal 23 of HED cell 3 to positive terminal 23′ of HED cell 4 and to negative terminal 23″ of HED cell 5 and to negative terminal 23″′ of HED cell 6. HED bus 14″ electrically connects HED cell 7 to HED cell 8. HED bus15 electrically connects positive terminal 27 of HED cell 1 to positive terminal 27′ of HED cell 2 and to negative terminal 27″ of HED cell 3 and to negative terminal 27″′ of HED cell 4. HED bus 15′ electrically connects HED cell 5 to HED cell 6 to HED cell 7 and to HED cell 8. The left end of HED bus 14′ is physically offset from the left end of HED bus 15′ by an offset distance along the length of module 26 that is equal to 2×W; wherein W=a width of each prismatic repeating battery sub-unit 70, 71, 72, etc. Also, the right end of HED bus 15 is physically offset from the left end of adjacent HED bus 15′ by an offset distance along the length of module 26 that is equal to W. The length of each electrical bus is equal to 4×W.

FIG. 1D shows an opposing, LED side 13 elevation view of the previous example of the prismatic battery module 26 with at least eight, prismatic repeating sub-units 70, 71, 72, 73, 74, 75, 76, and 77 with at least eight, alternating pairs of stacked HED prismatic battery cells 18, 18′, etc. and LED prismatic battery cells 22, 22′, etc., respectively, that are separated by at least eight, alternating pairs of Type-A and Type-B thermal barriers 20, 20′, etc. and 24, 24′, etc., respectively, that are disposed in-between the HED and LED cells. The specific battery architecture used for this example of battery module 26 is an “2P4S2AC” architecture, wherein each repeating battery sub-unit 70, 71, 72, etc. comprises two Parallel groups and eight Series groups and two Alternating Chemistries (i.e., “2P8S2AC”). Battery current, i, flows from left to right in module 26, when connected to a load (such as a traction motor (not shown)). The sideways-pointing arrow 79 (pointing to the right-hand side of FIG. 1D) indicates that battery module 26 may have as many multiple, repeating sub-units 70, 71, 72, etc. as is needed to supply the desired current and voltage levels needed for a specific battery architecture. Each LED bus 16, 17, 16′, 17′, and 16″ has a directional arrow indicating the flow of current, i, from left to right through each LED bus, in a serpentine fashion, during a battery discharge cycle. The current flow direction would reverse in a charging cycle.

Referring still to FIG. 1D, LED bus 16 electrically connects LED cell 1 to LED cell 2. LED bus 16′ electrically connects positive terminal 25 of LED cell 3 to positive terminal 25′ of LED cell 4 and to negative terminal 25″ of LED cell 5 and to negative terminal 25″′ of LED cell 6. LED bus 16″ electrically connects LED cell 7 to LED cell 8. LED bus 17 electrically connects positive terminal 29 of LED cell 1 to positive terminal 29′ of LED cell 2 and to negative terminal 29″ of LED cell 3 and to negative terminal 29″′ of LED cell 4. LED bus 17′ electrically connects LED cell 5 to LED cell 6 to LED cell 7 and to LED cell 8. The left end of HED bus 16′ is physically offset from the left end of HED bus 17′ by an offset distance along the length of module 26 that is equal to 2×W; wherein W=a width of each prismatic repeating battery sub-unit 70, 71, 72, etc. Also, the right end of HED bus 17 is physically offset from the left end of adjacent HED bus 17′ by an offset distance along the length of module 26 that is equal to W. The length of each electrical bus is equal to 4×W. This specific example of a battery architecture is a “2P8S2AC” (two Parallel, eight Series, two Alternating Chemistries) design.

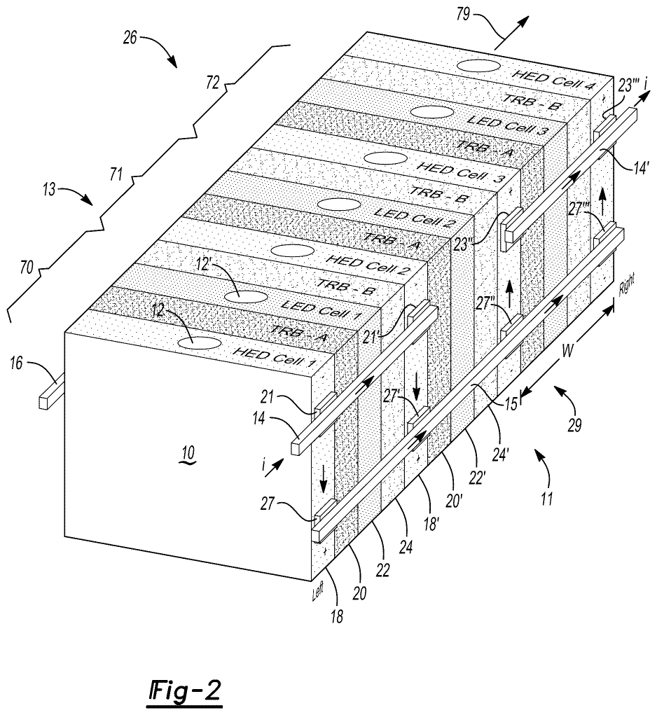

FIG. 2 shows a perspective view of the example of the previous prismatic battery module 26 comprising three, prismatic repeating sub-units 70, 71, 72 with three, alternating pairs of stacked HED and LED battery cells respectively, that are separated by thermal barriers. First HED bus 14 electrically connects HED cell 1 to HED cell 2. Second HED bus 14′ electrically connects the positive terminal 23 of HED cell 3 to the positive terminal 23′ of HED cell 4. Third HED bus 15 electrically connects the positive terminal 27 of HED cell 1 to the positive terminal 27′ of HED cell 2 and to the negative terminal 27″ of HED cell 3 and to the negative terminal 27″′ of HED cell 4. This specific embodiment of a battery architecture is a “2P4S2AC” (two Parallel, four Series, two Alternating Chemistries) design. The sideways-pointing arrow 79 (pointing to the right-hand side of FIG. 2) indicates that battery module 26 may have as many multiple, repeating sub-units 70, 71, 72, etc. as is needed to supply the desired current and voltage levels needed for a specific battery architecture.

Note that in the different view illustrated in FIGS. 1C and 1D, HED buses 15, 15′ and 14, 14′, 14″ are located on the HED side 11 of battery module 26; while the LED buses 17, 17′ and 16, 16′, 16″ are located on the opposite LED side 13 of battery module 26.

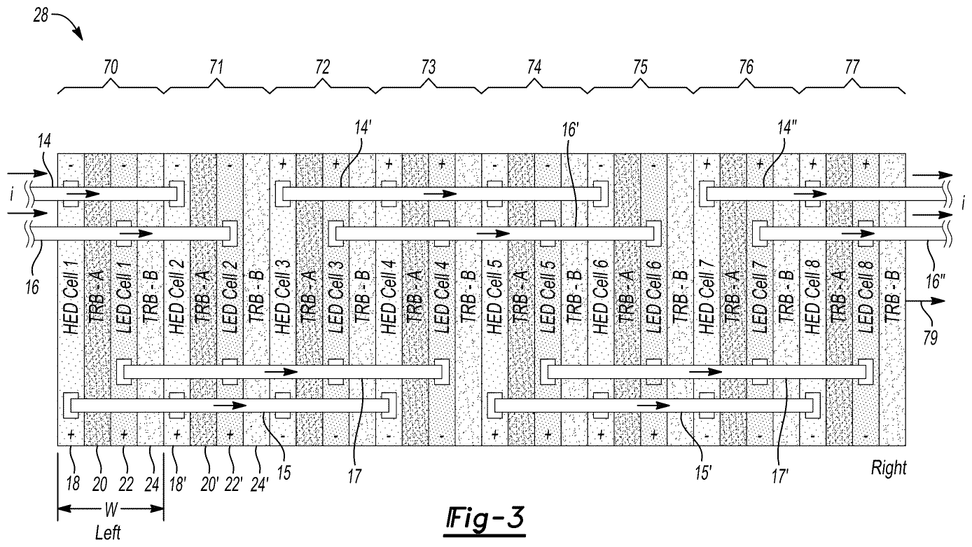

FIG. 3 shows a side elevation view of an example of a prismatic battery module 28 comprising eight, prismatic repeating sub-units 70, 71, 72, etc. with at least eight, alternating pairs of stacked HED prismatic battery cells 18, 18′, etc. and LED prismatic battery cells 22, 22′, etc., respectively, that are separated by eight, alternating pairs of Type-A and Type-B thermal barriers 20, 20′, etc. and 24, 24′, etc., respectively. First HED bus 14 electrically connects HED cell 1 to HED cell 2. Second HED bus 14′ electrically connects the positive terminal of HED cell 3 to the positive terminal of HED cell 4 and to the negative terminal of HED cell 5 and to the negative terminal of HED cell 6. Third HED bus 14″ electrically connects HED cell 7 to HED cell 8. Fourth HED bus 15 electrically connects the positive terminal of HED cell 1 to the positive terminal of HED cell 2 and to the negative terminal of HED cell 3 and to the negative terminal of HED cell 4. Fifth HED bus 15′ electrically connects HED cell 5 to HED cell 6 to HED cell 7 and to HED cell 8, in a similar fashion to fourth HED bus 15.

Referring still to FIG. 3, first LED bus 16 electrically connects LED cell 1 to LED cell 2. Second LED bus 16′ electrically connects the positive terminal of LED cell 3 to the positive terminal of LED cell 4 and to the negative terminal of LED cell 5 and to the negative terminal of LED cell 6. Third LED bus 16″ electrically connects LED cell 7 to LED cell 8. Fourth LED bus 17 electrically connects the positive terminal of LED cell 1 to the positive terminal of LED cell 2 and to the negative terminal of LED cell 3 and to the negative terminal of LED cell 4. Fifth LED bus 17′ electrically connects LED cell 5 to LED cell 6 to LED cell 7 and to LED cell 8, in a similar fashion to fourth LED bus 17.

Note, in the embodiment shown in FIG. 3, HED buses 15, 15′ and 14, 14′, 14″ are located on the same side of battery module 26 as where LED buses 17, 17′ and 16, 16′, 16″ are located. This specific example of a battery architecture is a “2P84S2AC” (two Parallel, eight Series, two Alternating Chemistries) design. The sideways-pointing arrow 79 (pointing to the right-hand side of FIG. 3) indicates that battery module 28 may have as many multiple, repeating sub-units 70, 71, 72, etc. as is needed to supply the desired current and voltage levels needed for a specific battery architecture.

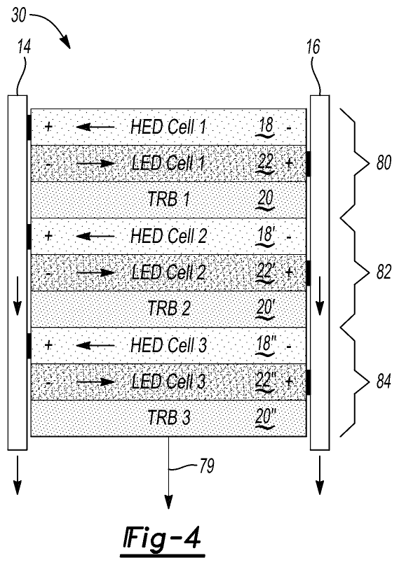

FIG. 4 shows a top plan view of an example of a prismatic battery module 30 comprising three, prismatic repeating sub-units 80, 82, and 84 with at least three, alternating pairs of stacked HED and LED prismatic battery cells 18, 18′, 18″ and 22, 22′, 22″, respectively, that are disposed directly adjacent to each other. First thermal barrier 20 is disposed in-between first LED prismatic battery cell 22 and second HED prismatic battery cell 18′. Second thermal barrier 20′ is disposed in-between second LED prismatic battery cell 22′ and third HED prismatic battery cell 18″. The downwards-pointing arrow 79 illustrated at the bottom of FIG. 4 indicates that battery module 30 may have as many multiple, repeating sub-units 80, 82, 84, etc. as is needed to supply the desired current and voltage levels needed for a specific battery architecture. Note, also, in this embodiment, no thermal barrier is disposed in-between the first HED prismatic battery cell 18 and the first LED prismatic battery cell 22. Likewise, no thermal barrier is disposed in-between the second HED prismatic battery cell 18′ and the second LED prismatic battery cell 22′. Likewise, no thermal barrier is disposed in-between the third HED prismatic battery cell 18″ and the third LED prismatic battery cell 22″.

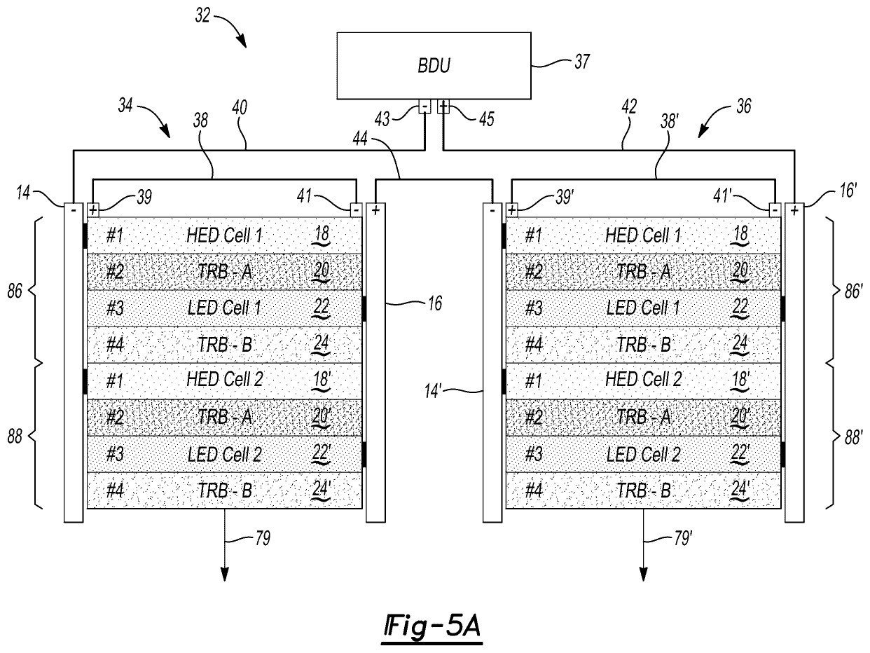

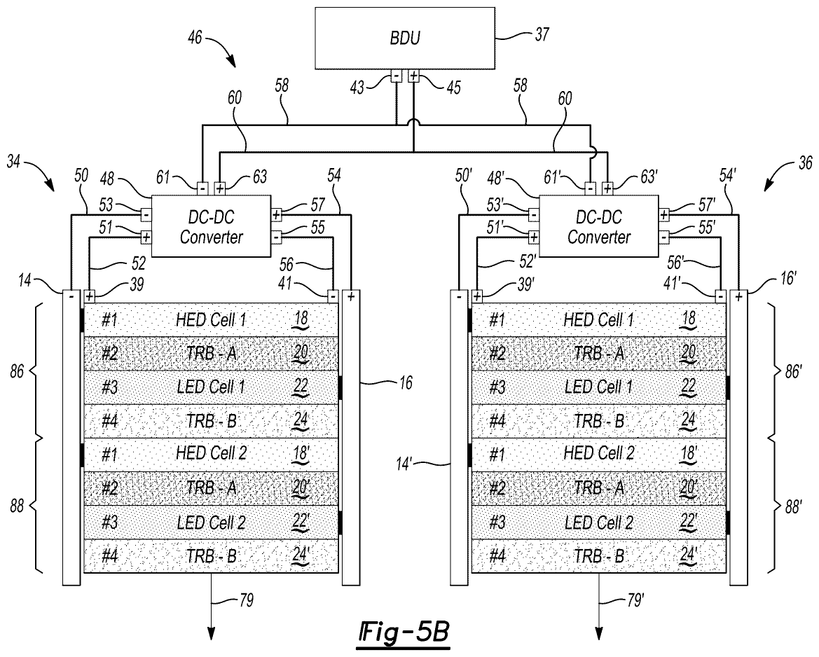

FIG. 5A shows a top plan view of an example of a battery pack 32 comprising a pair of first and second prismatic battery modules 34 and 36, respectively, that are electrically connected in parallel to a common Battery Disconnect Unit (BDU) 37. Each individual prismatic battery module 34 and 36 comprises multiple, prismatic repeating sub-units 86, 88, 86′, 88′, etc., respectively. Each repeating battery sub-unit 86, 88, 86′, 88′, etc., comprising multiple, alternating pairs of stacked HED and LED prismatic battery cells 18, 18′, etc. and 22, 22′, etc., respectively, which are separated by two types of thermal barriers: TB-A 20, 20′, etc. and TB-B 24, 24′, etc. Connector 38 electrically connects more positive tab 39 to the more negative tab 41 of first HED battery cell 18 in first module 34.

Referring still to FIG. 5A, connector 38′ electrically connects more positive tab 39′ to the more negative tab 41′ of first HED battery cell 18 in second module 36. Connector 40 electrically connects the HED bus 14 of first module 34 to negative tab 43 of BDU 37. Likewise, connector 42 electrically connects the LED bus 16′ of second module 36 to positive tab 45 of BDU 37. Jumper connector 44 electrically connects the LED bus 16 of first module 34 to the HED bus 14′ of second module 36. The downwards-pointing arrows 79 and 79′ illustrated at the bottom of FIG. 5A indicate that battery modules 34 and 36 may have as many multiple, repeating sub-units 86, 88, 86′, 88′, etc. as is needed to supply the desired current and voltage levels needed for a specific battery architecture.

FIG. 5B shows a top plan view of an example of a battery pack 46 comprising a pair of first and second prismatic battery modules 34 and 36, respectively, that are electrically connected in parallel to a pair of first and second DC-DC converters 48 and 48′, respectively, and then electrically connected in parallel to a common Battery Disconnect Unit (BDU) 37. Each individual prismatic battery module 34 and 36 comprises multiple, prismatic repeating sub-units 86, 88, 86′, 88′, etc. Each repeating battery sub-unit 86, 88, 86′, 88′, etc., comprising multiple alternating pairs of stacked HED and LED prismatic battery cells 18, 18′, etc. and 22, 22′, etc., respectively, are separated by two types of thermal barriers: TB-A 20, 20′, etc. and TB-B 24, 24′, etc., respectively. Connector 52 electrically connects more positive tab 39 of first HED battery cell 18 in first module 34 to positive tab 51 of first DC-DC converter 48.

Referring still to FIG. 5B, connector 56 electrically connects more negative tab 41 of first HED battery cell 18 in first module 34 to negative tab 55 of first DC-DC converter 48. Connector 50 electrically connects HED bus 14 of first module 34 to negative tab 53 of first DC-DC converter 48. Similarly, connector 54 electrically connects LED bus 16 of first module 34 to positive tab 57 of first DC-DC converter 48. The downwards-pointing arrows 79 and 79′ illustrated at the bottom of FIG. 5B indicate that battery modules 34 and 36 may have as many multiple, repeating sub-units 86, 88, 86′, 88′, etc. as is needed to supply the desired current and voltage levels needed for a specific battery architecture.

Referring still to FIG. 5B, connector 52′ electrically connects more positive tab 39′ of first HED battery cell 18 in second module 36 to positive tab 51′ of second DC-DC converter 48′. Similarly, connector 56′ electrically connects more negative tab 41′ of first HED battery cell 18 in second module 36 to negative tab 55′ of second DC-DC converter 48′. Connector 50′ electrically connects HED bus 14′ of second module 36 to negative tab 53′ of second DC-DC converter 48′. Similarly, connector 54′ electrically connects LED bus 16′ of second module 36 to positive tab 57′ of second DC-DC converter 48′. Connector 58 electrically connects negative tab 61′ of second DC-DC converter 48′ to negative tab 43 of BDU 37 and to negative tab 61′ of DC-DC converter 48′. Likewise, connector 60 electrically connects positive tab 63 of first DC-DC converter 48 to positive tab 45 of BDU 37 and to positive tab 63′ of second DC-DC converter 48′.

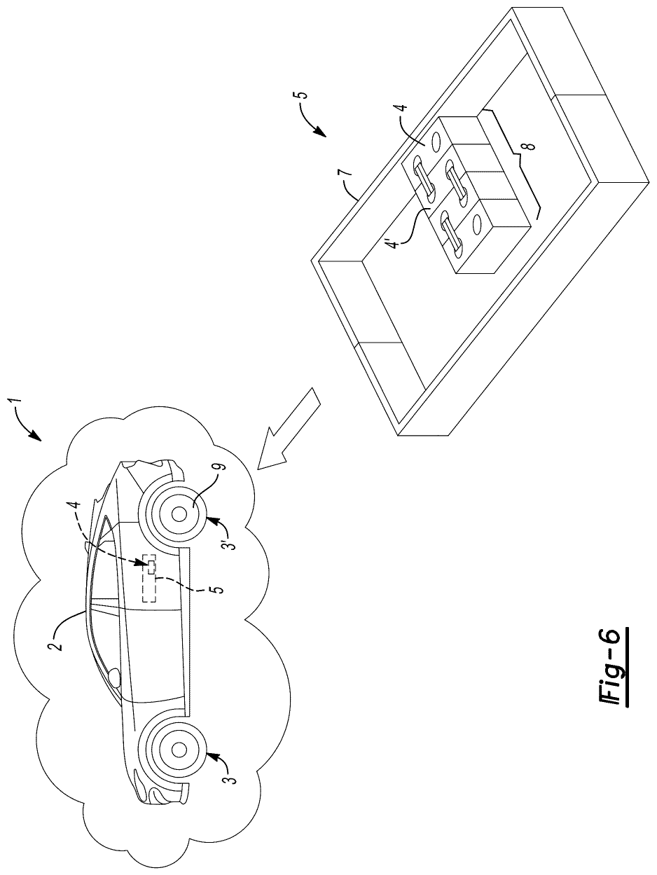

FIG. 6 shows a perspective view of an example of an automobile vehicle 1 with a vehicle body 2, two road wheels 3 and 3′, and a battery pack 5 comprising battery tray 7 attached to vehicle body 2. Battery tray 7 holds a prismatic battery module 8 comprising multiple, stacked prismatic battery cells 4, 4′, etc. Battery cells 4, 4′, etc. are electrically connected to drive traction motor 9, which is configured to drive road wheel 3′. Prismatic battery module 8 may be, for example, the embodiment illustrated in FIGS. 1A, 1B, 1C, 1D, and 12; or as illustrated in FIG. 3 or 4.

In some embodiments, the HED battery cells may comprise a lithium-nickel-manganese-cobalt battery chemistry, a lithium-nickel-cobalt-aluminum oxide battery chemistry, a lithium-manganese oxide chemistry, a lithium manganese-rich chemistry, or a sodium-ion based battery chemistry, and/or combinations thereof.

In some embodiments, the LED battery cells may comprise a Lithium-Iron-Phosphate (LiFePO₄) battery chemistry.

In some embodiments, the HED battery cells may have a high energy density that may range from about 580 WattHour/Liter to about 630 WattHour/Liter; and the LED battery cells may have a low energy density that may range from about 400 WattHour/Liter to about 450 WattHour/Liter.

In some embodiments, a ratio of high energy density divided by low energy density may be greater than about 1.1.

In other embodiments, the ratio of high energy density divided by low energy density may be greater than about 1.3.

In some embodiments, the HED battery cells and/or LED battery cells may use liquid electrolytes.

In some embodiments, the HED battery cells and/or LED battery cells may be solid-state batteries.

In some embodiments, a battery pack architecture may have alternating pairs of two, unique types of battery cells, i.e., a first type of battery cell that has a high energy density—“HED”, and a second type of battery cell that has a low energy density—“LED”.

In some embodiments, at the battery module level, cell-to-cell busbar connections may occur solely for the same battery cell chemistry. That means that every HED battery cell may be bussed together and, similarly, every LED battery cell may be bussed together, according to the desired parallel “P” electrical grouping architecture (e.g., 1P, 2P, 3P, 4P, etc.).

In some embodiments, at the battery pack level, individual module HV buses for HED and LED cells may be combined in series or parallel (or both) based on pack needs. Either an electrical contactor may connect them in series, or a DC-DC converter may be used to balance voltage differences between two or more parallel strands (due to the different cell chemistries having unique cell voltage temporal profiles).

In some embodiments, the alternating pairs of HED and LED battery cells may be configured to have their HED or LED cell terminals located on different sides of a battery module, so that each type of HV bus is separated onto their own, unique side of a prismatic battery module architecture. For example, the HED cells may be electrically bussed on the driver's side of a vehicle, and the LED cells may be bussed on the passenger's side, with the gas vents for both cell types being located on the remaining sides of each prismatic cell (e.g., cell vents may be located on the same side for both HED and LED cell types, or on different sides).

In some embodiments, both cell types may have their terminals located on a same side of a battery module. However, in this embodiment, the positioning of individual terminals of the cells would be physically offset such that the individual HED and LED HV bus connections may be made to keep each HV bus separate at the module level.

In some embodiments, during a thermal excursion event, a control system may be configured to detect which type of battery cell went into excursion by detecting each individual cell's voltage (since they are separately monitored). Hence, by measuring this, the high voltage current in either (or both) HV bus may be disconnected, depending on the particular vehicle's strategy. For example, if you want to power the vehicle for a “limp home mode” (e.g., emergency pullover event, TRP propulsion) after a HED cell goes into thermal excursion, the HED cell HV bus may be disconnected so that the cell(s) experiencing a shorting current does not receive additional current, thereby allowing a vehicle “limp home mode” powered by the still-connected LED cells.

In some embodiments, by alternating the battery chemistry according to the present disclosure, battery cell voltage monitoring may be used to measure and monitor the speed of thermal excursion propagation. This may be possible, since the sensing circuits are individually separated by each individual cell's connection. Thus, a monitoring system may independently identify when a HED or LED cell goes into thermal excursion. By doing this, a speed (velocity) of thermal excursion propagation may be tracked, thereby allowing a more accurate prediction of when an external overheating event may be expected to occur.

In some embodiments, once these unique HED and LED HV buses have been configured, individual cell sensing may be used for each HED and LED cell type, due to different cell voltage temporal profiles.

In some embodiments, by using individual cell sensing, when a cell goes into thermal runaway, individual cell voltage monitoring may identify which cell type went into thermal runaway.

In some embodiments, a battery management system may disconnect either a HED or LED cell from the vehicle power, such that it could remove current flow from the cell involved in a runaway strand, or in a vulnerable cell located adjacent to the involved cell.

In some embodiments, the high voltage bussing may be separated by each cell chemistry type. Each individual battery cell may have its own high voltage bussing, so that when a cell goes into thermal runaway, the conductive heat transfer goes to an adjacent battery cell having a different chemistry located next to it. Then, the electrical shorting and busbar conduction occurs to the cell located at two positions over from the same cell chemistry. This may result in a significantly improved thermal response performance and, accordingly, may result in thinner thermal barriers.

In some embodiments, a battery pack may have an alternating cell chemistry, wherein every other cell is a repeating unit.

In some embodiments, by separating the HV bussing and alternating cell positions, during thermal runaway propagation, the electrical shorting and busbar conductive heat transfer does not occur to the most vulnerable cell that sees the most conduction heat transfer through the thermal barrier.

In some embodiments, an active switchable pack architecture may use either DC-DC converters or series connection contactors to connect the separated-by-design high voltage buses of each cell chemistry type.

In some embodiment, the overall size of a thermal barrier between cells may be minimized by using a high thermal stability (and low energy density) cell as a thermal damper between the highly energetic (and low thermal stability) cells.

In some embodiments, the cell terminals may be placed in offset positions for each alternating cell type, thereby allowing for the HED and LED high voltage buses to be located on the same side of the battery module. This configuration reduces the amount of battery pack air space needed to have sufficient creepage and clearance distances for the battery terminals.

In some embodiments, no thermal barrier is required to be used to achieve good thermal performance between one of the HED and LED cells. Instead, every thermal barrier may be positioned after the LED cell. In this case, a trigger time for the LED cell doesn't significantly affect the trigger time to the next HED cell, which means that the remaining thermal barrier material may be allocated into one type of cell location to efficiently reduce or stop a thermal excursion propagation.

In some embodiments, the two types of thermal barriers, TB-A and TB-B, may be made of the same, or different, material(s); and/or they may have the same, or different thicknesses, depending on the required degree of thermal insulation. Each type (TB-A and/or TB-B) of thermal barrier may be made of an aerogel material, a compressed foam, mica, ceramic fibers, ceramic wool, or a metallic material, and/or combinations thereof. Also, each type (TB-A and/or TB-B) may have a thickness ranging from about 1 mm to about 10 mm.

In an example, a calculation was made of the total energy capacity of three different battery pack designs: (A) a monolithic pack design with every battery cell made of a single LiFePO4 battery chemistry type (i.e., a LED battery); (B) a monolithic pack design with every battery cell made of a single NMC battery chemistry type (i.e., a HED battery); and (C) a mixed pack design comprising alternating cells of LED/HED battery chemistries (as shown in FIG. 4). The total energy capacity of the all-LED pack design “A” was estimated to be about 130 KWhr. The total energy capacity of all-HED pack design “B” was estimated to be 150 KWhr, and the total energy capacity of the mixed LED/HED pack design “C” was estimated to be 160 KWhr. This calculation demonstrates that a mixed LED/HED pack design may have the largest energy capacity, even though it contains approximately 50% LED battery cells (which have a lower energy density). The reason for the highest performance of the mixed LED/HED pack design “C” is that the number of thermal barriers may be reduced roughly by 50% when the LED cell acts as its own thermal barrier, as illustrated in FIG. 4. The mixed LED/HED pack design “C” also had a better overall thermal response to a thermal excursion propagation event than the all-HED pack design “B”.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Every embodiment and example disclosed herein are non-limiting embodiments and non-limiting examples. The words “a”, “an”, “the”, “at least one”, and “one or more” are used interchangeably to indicate that at least one of the items is present.

Moreover, words of approximation, such as “about,” “almost,” “substantially,” “generally,” “approximately,” and the like, may each be used herein to denote “at, near, or nearly at,” or “within 0-10% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

What is claimed is:

1. A battery module, comprising:
a first prismatic repeating battery sub-unit comprising:
a first High Energy Density (HED) battery cell having a high energy density; and
a first Low Energy Density (LED) battery cell having a low energy density;
wherein the high energy density is greater than the low energy density.

2. The battery module of claim 1, further comprising:
a second prismatic repeating battery sub-unit that is stacked adjacent to the first prismatic repeating battery sub-unit, comprising:
a second HED battery cell having the high energy density; and
a second LED battery cell having the low energy density;
a first thermal barrier; and
a second thermal barrier;
wherein the first thermal barrier is disposed in-between the first HED battery cell and the first LED battery cell; and
wherein the second thermal barrier is disposed in-between the first LED battery cell and the second HED battery cell.

3. The battery module of claim 1, further comprising:
a second prismatic repeating battery sub-unit that is stacked adjacent to the first prismatic repeating battery sub-unit, comprising:
a second HED battery cell having the high energy density; and
a second LED battery cell having the low energy density; and
a thermal barrier;
wherein the first HED battery cell is positioned directly adjacent to the first LED battery cell;
wherein the second HED battery cell is positioned directly adjacent to the second LED battery cell;
wherein the thermal barrier is positioned in-between the first LED cell and the second HED cell; and
wherein the thermal barrier is not disposed in-between the first HED battery cell and the first LED battery cell.

4. The battery module of claim 3,
wherein the thermal barrier comprises an aerogel material, a compressed foam material, mica, ceramic fibers, ceramic wool, a metallic material, and/or combinations thereof; and
wherein the thermal barrier has a thickness ranging from about 1 mm to about 10 mm.

5. The battery module of claim 1, wherein the first HED battery cell has a lithium-nickel-manganese-cobalt battery chemistry, a lithium-nickel-cobalt-aluminum oxide battery chemistry, a lithium-manganese oxide chemistry, a lithium manganese-rich chemistry, or a sodium-ion based battery chemistry, and/or combinations thereof.

6. The battery module of claim 1, wherein the first LED battery cell has a lithium-iron-phosphate battery chemistry or a lithium manganese-rich chemistry, and/or combinations thereof.

7. The battery module of claim 1,
wherein the first HED battery cell has a lithium-nickel-manganese-cobalt battery chemistry, a lithium-nickel-cobalt-aluminum oxide battery chemistry, a lithium-manganese oxide chemistry, a lithium manganese-rich chemistry, or a sodium-ion based battery chemistry, and/or combinations thereof; and
wherein the first LED battery cell has a lithium-iron-phosphate battery chemistry or a lithium manganese-rich chemistry, and/or combinations thereof.

8. The battery module of claim 1, wherein a ratio of the high energy density divided by the low energy density is greater than about 1.1.

9. The battery module of claim 8, wherein the ratio of the high energy density divided by the low energy density is greater than about 1.3.

10. A battery module, comprising:
(a) a first prismatic repeating battery sub-unit comprising:
four adjacent positions, including a position #1, a position #2, a position #3, and a position #4, defined within the first prismatic repeating battery sub-unit, and stacked in increasing order from the position #1 to the position #2 to the position #3 to the position #4;
a first High Energy Density (HED) battery cell having a high energy density, located at the position #1;
a first Type-A thermal barrier (TB-A) located at the position #2;
a first Low Energy Density (LED) battery cell having a low energy density, located at the position #3; and
a first Type-B thermal barrier (TB-B) located at the position #4;
wherein the high energy density is greater than the low energy density.

11. The battery module of claim 10, wherein the first TB-A comprises a different composition and/or a different thickness than the first TB-B.

12. The battery module of claim 10, wherein both the first TB-A and the first TB-B comprise a same composition and/or a same thickness.

13. The battery module of claim 10, further comprising:
(b) a second prismatic repeating battery sub-unit stacked adjacent to the first prismatic repeating battery sub-unit;
wherein the second prismatic repeating battery sub-unit comprises a same stacking order as the first prismatic repeating battery sub-unit,
wherein the second prismatic repeating battery sub-unit comprises:
a second HED battery cell having the high energy density, located at the position #1;
a second TB-A, located at the position #2;
a second LED battery cell having the low energy density, located at the position #3; and
a second TB-B, located at the position and further comprising:
(c) a third prismatic repeating battery sub-unit stacked adjacent to the second prismatic repeating battery sub-unit;
wherein the third prismatic repeating battery sub-unit comprises the same stacking order as the first prismatic repeating battery sub-unit;
wherein the third prismatic repeating battery sub-unit comprises:
a third HED battery cell having the high energy density, located at the position #1;
a third TB-A, located at the position #2;
a third LED battery cell having the low energy density, located at the position #3; and
a third TB-B, located at the position and further comprising:
(d) a fourth prismatic repeating battery sub-unit stacked adjacent to the third prismatic repeating battery sub-unit;
wherein the fourth prismatic repeating battery sub-unit comprises the same stacking order as the first prismatic repeating battery sub-unit;
wherein the fourth prismatic repeating battery sub-unit comprises:
a fourth HED battery cell having the high energy density, located at the position #1;
a fourth TB-A, located at the position #2;
a fourth LED battery cell having the low energy density, located at the position #3; and
a fourth TB-B, located at the position #4; and further comprising:
(e) a fifth prismatic repeating battery sub-unit stacked adjacent to the fourth prismatic repeating battery sub-unit;
wherein the fifth prismatic repeating battery sub-unit comprises the same stacking order as the first prismatic repeating battery sub-unit; and
wherein the fifth prismatic repeating battery sub-unit comprises:
a fifth HED battery cell having the high energy density, located at the position #1;
a fifth TB-A, located at the position #2;
a fifth LED battery cell having the low energy density, located at the position #3; and
a fifth TB-B, located at the position #4; and further comprising:
(f) a sixth prismatic repeating battery sub-unit stacked adjacent to the fifth prismatic repeating battery sub-unit;
wherein the sixth prismatic repeating battery sub-unit comprises the same stacking order as the first prismatic repeating battery sub-unit; and
wherein the sixth prismatic repeating battery sub-unit comprises:
a sixth HED battery cell having the high energy density, located at the position #1;
a sixth TB-A, located at the position #2;
a sixth LED battery cell having the low energy density, located at the position #3; and
a sixth TB-B, located at the position #4.

14. The battery module of claim 13, further comprising:
a first negative HED terminal disposed on the first HED battery cell;
a second negative HED terminal disposed on the second HED battery cell;
a third negative HED terminal disposed on the third HED battery cell;
a fourth negative HED terminal disposed on the fourth HED battery cell;
a fifth negative HED terminal disposed on the fifth HED battery cell;
a sixth negative HED terminal disposed on the sixth HED battery cell;
a first positive HED terminal disposed on the first HED battery cell;
a second positive HED terminal disposed on the second HED battery cell;
a third positive HED terminal disposed on the third HED battery cell;
a fourth positive HED terminal disposed on the fourth HED battery cell;
a fifth positive HED terminal disposed on the fifth HED battery cell;
a sixth positive HED terminal disposed on the sixth HED battery cell;
a first negative LED terminal disposed on the first LED battery cell;
a second negative LED terminal disposed on the second LED battery cell;
a third negative LED terminal disposed on the third LED battery cell;
a fourth negative LED terminal disposed on the fourth LED battery cell;
a fifth negative LED terminal disposed on the fifth LED battery cell;
a sixth negative LED terminal disposed on the sixth LED battery cell;
a first positive LED terminal disposed on the first LED battery cell;
a second positive LED terminal disposed on the second LED battery cell;
a third positive LED terminal disposed on the third LED battery cell;
a fourth positive LED terminal disposed on the fourth LED battery cell;
a fifth positive LED terminal disposed on the fifth LED battery cell; and
a sixth positive LED terminal disposed on the sixth LED battery cell.

15. The battery module of claim 14, further comprising:
a first HED bus electrically connecting the first positive HED terminal to the second positive HED terminal and to the third negative HED terminal and to the fourth negative HED terminal;
a second HED bus electrically connecting the third positive HED terminal to the fourth positive HED terminal and to the fifth negative HED terminal and to the sixth positive HED terminal;
a first LED bus electrically connecting the first positive LED terminal to the second positive LED terminal and to the third negative LED terminal and to the fourth negative LED terminal; and
a second LED bus electrically connecting the third positive LED terminal to the fourth positive LED terminal and to the fifth negative LED terminal and to the sixth negative LED terminal.

16. The battery module of claim 15, comprising:
a first side and an opposing second side;
wherein the first HED bus and the second HED bus are located on the first side; and
wherein the first LED bus and the second LED bus are located on the opposing second side.

17. The battery module of claim 15, wherein the first HED bus, the second HED bus, the first LED bus, and the second LED bus are located on a same side of the battery module.

18. The battery module of claim 10, further comprising:
a second prismatic repeating battery sub-unit electrically connected in parallel to the first prismatic repeating battery sub-unit; and
a Battery Disconnect Unit (BDU) electrically connected to the first prismatic repeating battery sub-unit and to the second prismatic repeating battery sub-unit;
wherein the second prismatic repeating battery sub-unit comprises:
four adjacent positions, including a position #1, a position #2, a position #3, and a position #4, defined within the first prismatic repeating battery sub-unit, and stacked in increasing order from the position #1 to the position #2 to the position #3 to the position #4;
a second HED battery cell located at the position #1, having the HED energy density;
a second Type A thermal barrier cell located at the position #2;
a second LED battery cell located at the position #3, having the LED energy density; and
a second Type B thermal barrier cell located at the position #4.

19. The battery module of claim 18, further comprising:
a first DC-DC converter electrically connected between the first prismatic repeating battery sub-unit and the BDU; and
a second DC-DC converter electrically connected between the second prismatic repeating battery sub-unit and the BDU.

20. A vehicle, comprising:
a vehicle body;
a road wheel connected to the vehicle body;
an electric traction motor rotatably connected to the road wheel; and
a battery module electrically connected to the electric traction motor and configured to energize the electric traction motor to cause rotation of the road wheel;
wherein the battery module comprises a prismatic repeating battery sub-unit comprising:
a High Energy Density (HED) battery cell having a high energy density; and
a Low Energy Density (LED) battery cell having a low energy density; and
wherein the high energy density is greater than the low energy density.
